(19) United States
(12) Patent Application Publication
(10) Pub. No.: US 2002/0077917 A1
(43) Pub. Date: Jun. 20, 2002

(54) Unique sales article identification

(76) Inventor: David Teller, Novato, CA (US)

Correspondence Address: David Teller, 530 Alameda del Prado, Novato, CA, 94949, US

(21) Appl. No.: 09/736,115

(22) Filed: Dec. 14, 2000

(51) Int. Cl. G06F 17/60

(52) U.S. Cl. 705/26

(57) ABSTRACT

A sales article such as a garment is provided with a unique identification number that is fixed to the sales article and is associated with article information that is stored in a database and can be retrieved from a computer network. The identification number is assigned to a particular sales article and is unique to that article. The article information is updated by authorized persons, such as retail store personnel. The article information in the database can be accessed upon supplying an authorization identifier to a database server.

### BACKGROUND OF THE INVENTION

1. Field of the Invention

This invention relates to identification of sales articles and, more particularly, to a system and database for registering and updating the status of articles.

2. Description of Related Art

For conventional mass market retailing of articles, it is typical for products to be identified with an item number or a stock unit number or other related characteristic. In the case of clothing, for example, the item number can identify a product code, garment type, style, manufacturer, or other characteristic, such as color and size. The item number is useful in tracking inventory levels, sales, and the like. With such information, retailers and distributors can better determine which articles of clothing are in greater demand and can thereby decide when to order more inventory and how much marketing effort should be devoted to particular products. Similar considerations apply to grocery store sales of canned and boxed goods, to identify preferred brands and container sizes. In the case of store shopping locations, information on sales can indicate the amount of floor space and sales clerk effort that should be devoted to particular products or articles of clothing. In the case of on-line retailing, sales information can be used to determine the amount of web site pages that should be devoted to products, or which articles should be the subject of special promotions.

Some goods may be produced with a measure of exclusivity. This is particularly the case for discretionary or luxury purchases. For example, many buyers of clothing are willing to pay a premium price for specialized garments that have design detailing, slogans, or logos that distinguish the garments from others. Such garments are typically perceived as having an extra measure of exclusivity, such as where garments with the logo of a designer that fetch a premium price. Other garments may sell for higher prices if geographic information such as the shop or city of purchase is placed on the clothing. Thus, in comparison with non-specialized clothing, there is a desire to achieve a measure of uniqueness or distinction for a garment, yet also remain part of a perceived exclusive group, comprising the class of “designer wear” goods or clothing purchased at a particular location.

Specialized, branded garments such as described above are more popular today than in years past, and are particularly popular With younger-aged demographic groups, such as children aged 12-17 years old and young adults aged 18-25 years old. These segments of the buying public are more likely to desire and wear specialized garments, and to purchase them for a premium price.

Another demographic trend is an increasing computer literacy in the marketplace, especially persons in economic groups that have greater available income for discretionary purchases, such as specialized garments. For example, an increasing amount of retail commerce is taking place over the Internet, as the public makes purchases using computers at home and work. Most of these purchases are for discretionary articles, such as clothing. Clothing and other discretionary or luxury articles directed to these market segments would sell for premium prices and have greater demand.

From the discussion above, it should be apparent that there is a need for promoting exclusivity in sales of articles that are directed at market segments more likely to purchase specialized goods at premium prices. The present invention fulfills this need.

### SUMMARY OF THE INVENTION

The invention provides a sales article with a unique identification number that is permanently fixed to the article and is associated with article information that is stored in a database and can be retrieved from multiple computers of a computer network. The identification number is assigned to a particular article and is unique to that article. The article information can only be updated and accessed by authorized persons, such as retail store personnel or other persons who have an appropriate authorization identifier. In this way, the travels of the article can be tracked in a database as the article acquires a unique history. Thus, sales articles can assume an aura of exclusivity with the capability of unique identification, and the update capability will especially appeal to persons in market segments who are more likely to purchase such goods. This will engender increased customer loyalty. In addition, an Internet web site associated with the database can attract customers to the web site and to retail store locations for additional purchases.

In one aspect of the invention, the updated sales article information comprises information other than inherent characteristics of the article. For example, the article information can include date of update, customer identification, location data, and other information other than article related characteristics of style, color, size, and the like. In this way, a customer can update the article information by presenting himself or herself at a store location, whereupon a store employee can enter the updated information into the database. This permits a customer to maintain, for example, a travelogue of store locations visited, or to track changes in ownership of the article subsequent to the initial purchase.

Other features and advantages of the present invention should be apparent from the following description of the preferred embodiment, which illustrates, by way of example, the principles of the invention.

### BRIEF DESCRIPTION OF DRAWINGS

FIG. 1 is a representation of an article of clothing manufactured in accordance with the present invention.

FIG. 2 is a flow diagram that illustrates the business method of implementing the database for articles in accordance with the present invention.

FIG. 3 is a block diagram representation of a computer system that supports the database business method illustrated in FIG. 2.

FIG. 4 is a flow diagram that illustrates the steps performed in accessing and updating the database illustrated in FIG. 2.

FIG. 5 is a representation of an identification plate permanently affixed to an article of furnishing in accordance with the present invention.

### DESCRIPTION OF THE DRAWINGS

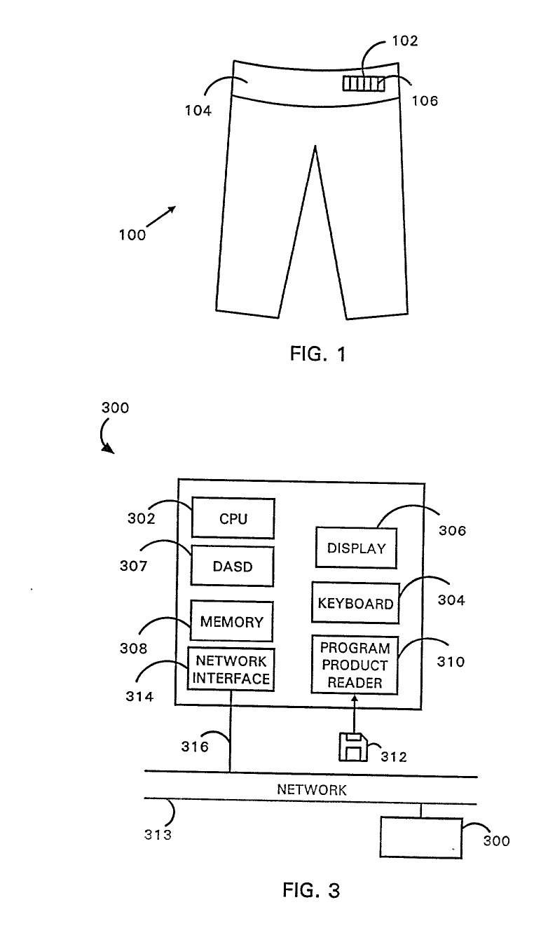

FIG. 1 shows an article of clothing 100 constructed in accordance with the present invention. The garment 100 may comprise, for example, pants made with conventional denim jeans material. Although illustrated garment is shown as pants, other articles of clothing may be utilized without departing from the teachings of the invention. For example, shoes, school bags, back packs, and other such consumer items could be identified in the manner to be described. In FIG. 1, the garment 100 has an article identification label 102 sewn into the pants waistband 104. The clothing identification label includes an article identification number 106 that is a unique number assigned to the particular article of clothing. The article identification number may be assigned during manufacture or assembly, or may be assigned at the time of purchase, so long as no other sales article is assigned the same number. Thus, each manufactured article is uniquely identified. Information associated with the garment, but not to a garment related characteristic such as color, style or size is stored in a computer Article Database and identified by the garment identification number. The article identification number may be represented by a bar code pattern that corresponds to the article identification number so the article number can be easily read with optical scanning equipment or can otherwise be easily input into a computer system. The number may also be in a form so it can be viewed by persons without the aid of special equipment, such as bar code readers.

The article identification label 102 is permanently fixed to the sales article 100, such that the label cannot be removed without leaving a clear indication of its removal. Preferably, a seal or fastener will be broken with any removal and will deface the label 102. Thus, it will be apparent if a label is attached to a garment 100 after first having been removed from another garment. This reduces the likelihood of counterfeit activity and incorrect linking between an article and data in the Article Database.

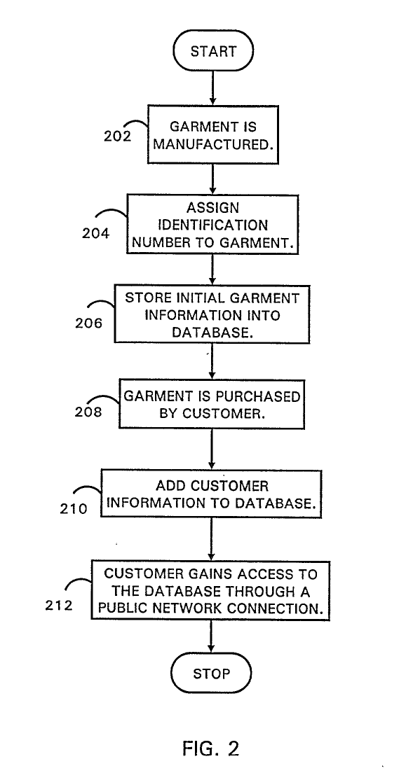

FIG. 2 shows the steps of the business method that permits tracking of the article history for the garment 100 in conjunction with the Article Database of the present invention. In the first step of the method, illustrated by the flow diagram box numbered 202, the article is manufactured. Next, the article is assigned an article identification number that is unique to the particular item, such as the pants illustrated in FIG. 1. The number assignment step is represented by the flow diagram box numbered 204. In the next processing step, indicated by the flow diagram box numbered 206, the initial article information is stored into a conventional computer database. In accordance with conventional computer database operation, the article information is automatically linked with the corresponding article identification number. Eventually, the article is purchased in a retail transaction by an individual customer. The purchase event is represented by the flow diagram box numbered 208.

It should be understood that the garment identification (box 204) and initial data entry (box 206) may take place at the same time as purchase (box 208) or may take place during the manufacturing process. The entered article information typically will include information other than such inherent article related characteristics as, for example, date of manufacture, location of manufacture, location of sale, textile information, style, size, color, and the like. Rather, the entered article information may include customer name, store of purchase, and date of purchase.

At the time of the retail transaction or sale, an authorized person such as a store employee gains access to the computer database through appropriate procedures explained further below and inputs the customer data called for by the data base interface. The customer data is then stored into the database. The step of adding to the database is represented by the flow diagram box numbered 210. Finally, at a later time, the customer can access the computer database for viewing the information through a computer network, as indicated by the flow diagram box numbered 212. The customer access to the database can comprise, for example, conventional Internet access through a web browser to a web site through which the Article Database is viewed. In that scenario, the web browser would communicate with a database server to retrieve the stored data from the Article Database. The Internet access is advantageous because owners of the article can more easily access the database of article information. In addition, with direct owner access, various marketing tie-ins with the article identification number feature are more plentiful.

For example, if the article identification number is assigned at the time of purchase, then the purchase transaction or article can be associated with an astrological sign, which is quite popular among many segments of the buying public. Another option is to link garments purchased at different locations but at simultaneous times, or otherwise associate them in the database. Similarly, articles with other characteristics in common could be linked through the database, such as color or style, place of manufacture, place of purchase, owner name, and so forth. A “fortune” or prediction or other story line could be developed, based on the time or location of purchase. Number entries to a sweepstakes or other prize drawing may be used. Well-worn garments or well-traveled articles may be issued plaques. Many other marketing features can be linked to the garments and articles through different databases, and they may be linked to each other, in other imaginative ways that will occur to those skilled in the art.

Another feature of the database provided by updating information (box 210) and accessing the database (box 212) is the ability to track the locations where the article has traveled, such as where a garment has been worn. This adds to the exclusivity of an individual garment, because the garment itself is necessary to update information in the garment database. That is, a sales clerk or other authorized person must enter update data upon verifying the information, after a person presents himself or herself in the garment at a store location. In this way, some garments may acquire special value as collector's items for having particular histories.

FIG. 3 is a block diagram of a computer constructed in accordance with the present invention. The processing that is performed by the Article Database system, as described in FIG. 2, may be performed on multiple computers all having a similar construction, or may be performed by a single, integrated computer. For example, the computer through which the customer gains access may be separate from the database server computer, or may be integrated with it. In either arrangement, the computers performing the processing may have a construction as illustrated in FIG. 3.

FIG. 3 is a block diagram of an exemplary computer 300 of the Article Database system. Each computer 300 operates under control of a central processor unit (CPU) 302, such as a “Pentium” microprocessor and associated integrated circuit chips, available from Intel Corporation of Santa Clara, Calif., USA. A computer user can input commands and data from a keyboard and display mouse 304, and can view inputs and computer output at a display 306. The display is typically a video monitor or flat panel display device. The computer 300 also includes a direct access storage device (DASD) 307, such as a fixed hard disk drive. The memory 308 typically comprises volatile semiconductor random access memory (RAM). Each computer preferably includes a program product reader 310 that accepts a program product storage device 312, from which the program product reader can read data (and to which it can optionally write data). The program product reader can comprise, for example, a disk drive, and the program product storage device can comprise removable storage media such as a magnetic floppy disk, an optical CD-ROM disc, a CD-R disc, a CD-RW disc, or a DVD data disc. If desired, the computers can be connected so they can communicate with each other, and with other connected computers, over a network 313. Each computer 300 can communicate with the other connected computers over the network 313 through a network interface 314 that enables communication over a connection 316 between the network and the computer.

The computer 300 operates under control of programming steps that are temporarily stored in the memory 308 in accordance with conventional computer construction. When the programming steps are executed by the CPU 302, the pertinent system components perform their respective functions. Thus, the programming steps implement the functionality of the system as described in FIG. 2. The programming steps can be received from the DASD 307, through the program product reader 312, or through the network connection 316. The storage drive 310 can receive a program product, read programming steps recorded thereon, and transfer the programming steps into the memory 308 for execution by the CPU 302. As noted above, the program product storage device 310 can comprise any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 308 over the network 313. In the network method, the computer receives data including program steps into the memory 308 through the network interface 314 after network communication has been established over the network connection 316 by well-known methods that will be understood by those skilled in the art without further explanation. The program steps are then executed by the CPU 302 to implement the processing of the Article Database system.

It should be understood that all of the computers of the system preferably have a construction similar to that shown in FIG. 3, so that details described with respect to the FIG. 3 computer 300 will be understood to apply to all computers of the system 300. This is indicated by multiple computers 300 shown connected to the network 313. Any one of the computers 300 can have an alternative construction, so long as they can communicate with the other computers and support the functionality described herein.

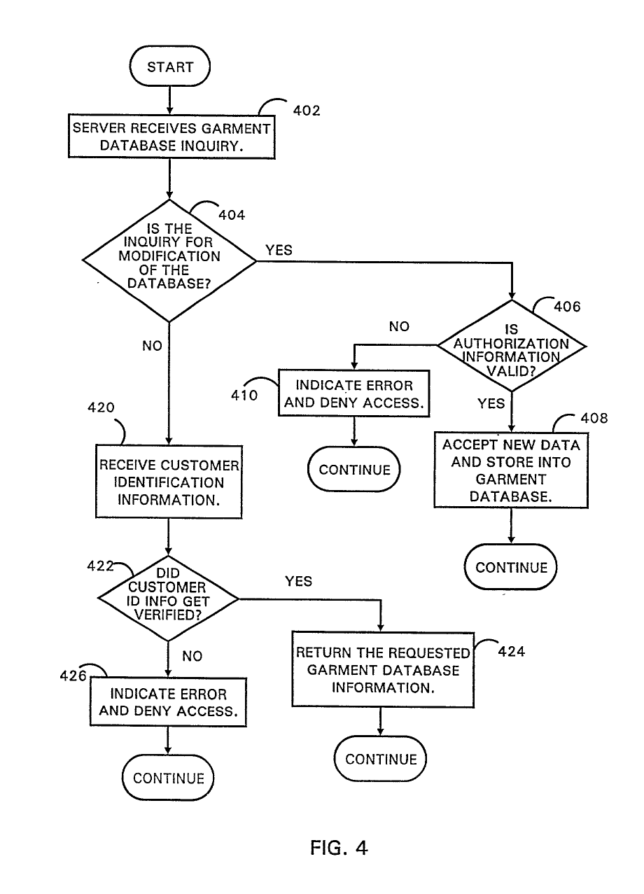

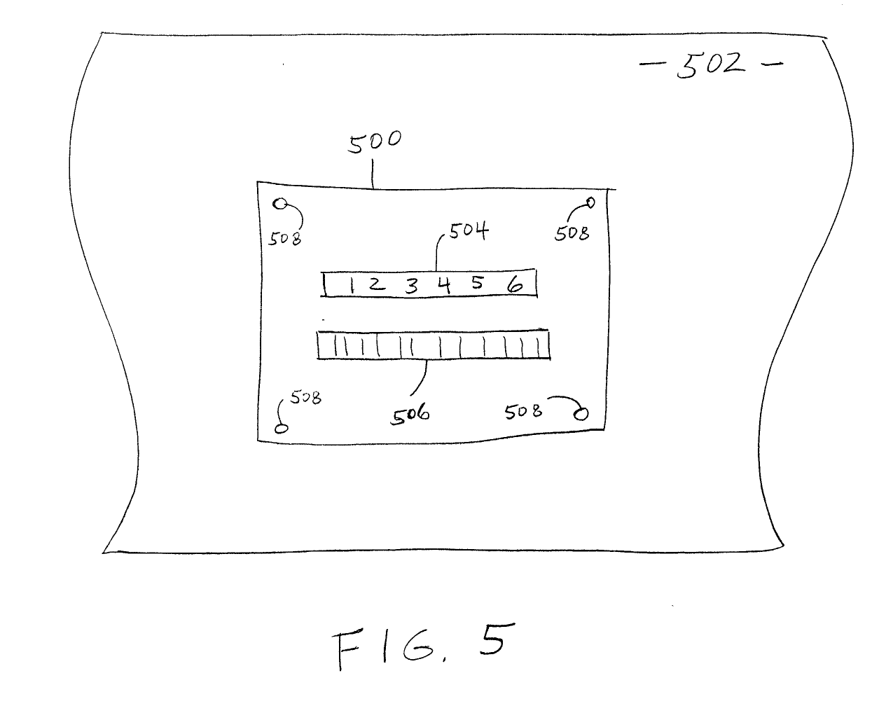

FIG. 4 shows the steps performed in accessing and updating the Article Database that is used in accordance with the steps of FIG. 2, as implemented by a database computer such as illustrated in FIG. 3. In the first step of computer processing, represented by the flow diagram box numbered 402, a database server computer receives an article inquiry. In the next step, the server checks to determine if the inquiry is a request to modify the information in the database. This step is represented by the flow diagram decision box numbered 404.

If the database inquiry is a modification request, an affirmative outcome at the decision box 404, then the server next checks for receipt of proper authorization, indicated by the decision box numbered 406. If the server receives an appropriate authorization identifier, an affirmative outcome at the decision box, then an authorization code is accepted by the server, which enters it into the database. The data entry step is indicated by the flow diagram box numbered 408. The authorization identifier received in step 406 may comprise, for example, a store location code and a assigned password. The data entry should preferably identify the person entering the data, for fraud control purposes. Similarly for fraud control, the data entry is preferably made only through computer equipment at a retail store location. If the authorization code is not verified, a negative outcome at the decision box 406, then an error message is displayed and database updating privileges are denied, as indicated by the flow diagram box numbered 410.

If the database inquiry received by the server is not a database update request, a negative outcome at the decision box 404, then the server recognizes that the inquiry is from a customer or retailer who wants to view the database information, and the server therefore processes owner information. The owner information processing step is indicated at the flow diagram box numbered 420. The person making the database inquiry must provide appropriate ownership information, to ensure privacy of legitimate owners and prevention of improper access or harassment from unauthorized persons. Therefore, at the decision box numbered 422, the server verifies the owner information to ensure that the information entered at the retail location matches the information in the database. It should be noted that a certain degree of vigilance and information verification should take place at the retail location, to help further reduce fraudulent or unauthorized database inquires. Accordingly, the database information is retrieved if the server computer verifies the owner information, as represented by the affirmative outcome at the decision box 422 and the flow diagram box numbered 424. If the owner information is not verified, a negative outcome at the decision box 422, then an error message is provided, and the data is not retrieved, at the flow diagram box numbered 426.

Thus, the invention provides a system and method for providing a sales article with a permanently affixed unique article identification number that follows the sales article through its history and travels. Although the preferred embodiment has been described with respect to a sales article comprising a garment (FIG. 1), it should be understood that the principles of the invention may be applied to other sales articles. As described above for the preferred embodiment, an article identification label having the article number is attached to the article such that the label cannot be removed without defacing the article. Thus, articles other than clothing garments can be so identified. For example, identification numbers can be integrally molded or embossed into the article.

FIG. 5 illustrates an identification plate 500 constructed in accordance with the present invention. The plate is shown permanently attached to a portion of a rigid sales article 502 that may comprise, for example, a chair or other furnishing product. The plate includes an embossed or engraved article identification number 504 and, if desired, a bar code representation 506 of the number. The plate 500 is permanently attached with rivets 508 such that any attempt to remove the plate will result in defacing the chair and also the plate. In this way, the identification plate 500 is permanently fixed to the sales article 500, and is associated with article information that is stored in a database and can be retrieved from the computer Article Database described above. For the illustrated chair, for example, the article information may include original place of sale, owners, and places of ownership or locations of display. Other pertinent information may be included that may be of particular interest to those with an interest in antique furniture.

The present invention has been described above in terms of a presently preferred embodiment so that an understanding of the present invention can be conveyed. There are, however, many configurations for database systems not specifically described herein but with which the present invention is applicable. For example, the unique item identification number and corresponding database with customer access can be implemented for products other than garments where exclusivity is a factor in demand, such as athletic equipment, personal accessories, and the like. The present invention should therefore not be seen as limited to the particular embodiment described herein, but rather, it should be understood that the present invention has wide applicability with respect to database systems generally. All modifications, variations, or equivalent arrangements and implementations that are within the scope of the attached claims should therefore be considered to be within the scope of the invention.

I claim:

1. A method of maintaining a database relating to a sales article, comprising:
assigning a unique identification number to the sales article;
storing initial article information into an Article Database in accordance with the article identification number;
associating an article authorization identifier with the article information in the database for a customer who purchases the sales article;
adding information that relates to the sales article into the Article Database; and
accessing the Article Database to retrieve the initial article information and the added article information.

2. A method as defined in claim 1, wherein assigning the article identification number occurs at approximately the time of article manufacture.

3. A method as defined in claim 1, wherein assigning the article identification number occurs at approximately the time the customer purchases the sales article.

4. A method as defined in claim 1, wherein assigning the article identification number comprises recording the identification number onto a label that is permanently affixed to the sales article.

5. A method as defined in claim 1, wherein storing initial article information comprises storing information other than article related inherent characteristics.

6. A method as defined in claim 1, wherein storing initial article information comprises storing customer information, including customer name and date of purchase.

7. A method as defined in claim 1, wherein adding information into the Article Database comprises storing customer information, including customer name and date of purchase, into the Article Database.

8. A method as defined in claim 1, wherein adding information into the Article Database comprises storing information comprising the date of adding information and the location from which the information was added.

9. A method as defined in claim 1, wherein storing initial article information comprises storing the information into a computer network database.

10. A method as defined in claim 1, wherein accessing the Article Database comprises accessing a computer network database in which the article information is stored.

11. A method as defined in claim 1, wherein the Article Database is stored on a computer network, and adding information comprises:
providing a network authorization code to gain access to the computer network;
providing an Article Database authorization code to gain access to the Article Database; and
storing added information into the Article Database.

12. A method as defined in claim 1, wherein the Article Database is stored on a computer network, and accessing the Article Database comprises:
providing a network authorization code to gain access to the computer network;
providing an Article Database authorization code to gain access to the Article Database; and
retrieving information stored in the Article Database.

13. A method as defined in claim 1, wherein the sales article is a garment worn by an individual.

14. A method as defined in claim 1, wherein the sales article is a furnishing product.

15. A sales article comprising:
a product that can be possessed by an individual; and
a label that is permanently affixed to the sales article and that includes a unique article identification number assigned to the sales article;
wherein the article identification number is linked to a data record in an Article Database that contains initial article information relating to the article, is associated with an article authorization identifier for a customer who purchases the sales article, and that receives added information that relates to the article, such that the information in the Article Database can be accessed by an authorized customer to retrieve the initial article information, and the added article information for the identified article.

16. A sales article as defined in claim 15, wherein the article identification number is assigned at approximately the time of article manufacture.

17. A sales article as defined in claim 15, wherein the article identification number is assigned at approximately the time the customer purchases the article.

18. A sales article as defined in claim 15, wherein the initial article information comprises storing information other than article related inherent characteristics.

19. A sales article as defined in claim 15, wherein the initial article information includes customer information, including customer name and date of purchase.

20. A sales article as defined in claim 15, wherein the information added into the Article Database includes customer information, including customer name and date of purchase.

21. A sales article as defined in claim 15, wherein the information added into the Article Database includes the date of adding the information and the location from which the information was added.

22. A sales article as defined in claim 15, wherein the initial article information associated with the sales article comprises information that is stored into a computer network database.

23. A sales article as defined in claim 15, wherein the Article Database is accessed after first accessing a computer network database in which is stored the information associated with the sales article.

24. A sales article as defined in claim 15, wherein the Article Database is stored on a computer network, and the added information is stored only after a network computer first receives a network authorization code to gain access to the computer network and then receives an Article Database authorization code to gain access to the Article Database.

25. A sales article as defined in claim 15, wherein the Article Database is stored on a computer network, and the Article Database information is accessed and information is retrieved only after a network computer first receives a network authorization code to gain access to the computer network and then receives an Article Database authorization code to gain access to the Article Database.

26. A sales article as defined in claim 15, wherein the sales article is a garment worn by an individual.

27. A sales article as defined in claim 15, wherein the sales article is a furnishing product.

28. A computer system comprising:
a data access computer; and
a database computer that is linked to the data access computer for exchanging data relating to one or more sales articles;
wherein the database computer maintains an Article Database that stores article identification numbers, each of which is linked to a data record containing initial article information that relates to the article and is associated with an article authorization identifier for a customer who purchases the article, and wherein the database computer receives added information that relates to the article, such that the information in the Article Database can be accessed from the data access computer by an authorized customer to retrieve the initial article information, and the added article information for the identified sales article.

29. A computer system as defined in claim 28, wherein the article identification number is assigned at approximately the time of article manufacture.

30. A computer system as defined in claim 28, wherein the article identification number is assigned at approximately the time the customer purchases the sales article.

31. A computer system as defined in claim 28, wherein the initial article information comprises information other than article related inherent characteristics.

32. A computer system as defined in claim 28, wherein the initial article information includes customer information, including customer name and date of purchase.

33. A computer system as defined in claim 28, wherein the information added into the Article Database includes customer information, including customer name and date of purchase.

34. A computer system as defined in claim 28, wherein the information added into the Article Database includes the date of adding the information, and the location from which the information was added.

35. A computer system as defined in claim 28, wherein the initial article information associated with the sales article comprises information that is stored into a computer network database.

36. A computer system as defined in claim 28, wherein the Article Database is accessed after first accessing a computer network database in which is stored the information associated with the sales article.

37. A computer system as defined in claim 28, wherein the Article Database is stored on a computer network, and the added information is stored only after a network computer first receives a network authorization code to gain access to the computer network and then receives an Article database authorization code to gain access to the Article Database.

38. A computer system as defined in claim 28, wherein the Article Database is stored on a computer network, and the Article Database information is accessed and information is retrieved only after a network computer first receives a network authorization code to gain access to the computer network and then receives an Article Database authorization code to gain access to the Article Database.

39. A computer system as defined in claim 28, wherein the sales article comprises a garment worn by an individual.

40. A computer system as defined in claim 28, wherein the sales article comprises a furnishing product.

41. A database stored in memory of a database computer, the database comprising:
a plurality of article identification numbers, each of which is uniquely assigned to and associated with a different sales article having a label that is permanently affixed thereto;
a plurality of data records, each of which is linked to one of the article identification numbers, each data record containing initial article information that relates to the article and is associated with an article authorization identifier for a customer who purchases the sales article, and wherein the database computer is connected to a computer network and the data records are supplemented with added information that relates to the sales article, such that the information can be accessed from a data access computer of the computer network by an authorized customer to retrieve the initial article information and the added article information for the identified sales article.

42. A database as defined in claim 41, wherein the article identification number is assigned at approximately the time of article manufacture.

43. A database as defined in claim 41, wherein the article identification number is assigned at approximately the time the customer purchases the sales article.

44. A database as defined in claim 41, wherein the initial article information comprises storing information other than article related inherent characteristics.

45. A database as defined in claim 41, wherein the initial article information includes customer information, including customer name and date of purchase.

46. A database as defined in claim 41, wherein the information added into the database includes customer information, including customer name and date of purchase.

47. A database as defined in claim 41, wherein the information added into the database includes the date of adding the information, and the location from which the information was added.

48. A database as defined in claim 41, wherein the initial article information associated with the sales article comprises information that is stored into a computer network database.

49. A database as defined in claim 41, wherein the article database is accessed after first accessing a computer network database in which is stored the information associated with the sales article.

50. A database as defined in claim 41, wherein the article database is stored on a computer network, and the added information is stored only after a network computer first receives a network authorization code to gain access to the computer network and then receives an article database authorization code to gain access to the database.

51. A database as defined in claim 41, wherein the database is stored on a computer network, and the database information is accessed and information is retrieved only after a network computer first receives a network authorization code to gain access to the computer network and then receives a database authorization code to gain access to the database.

52. A database as defined in claim 41, wherein the sales article comprises a garment worn by an individual.

53. A database as defined in claim 41, wherein the sales article comprises a furnishing product.

54. A method of maintaining a database relating to a sales article, the method comprising:
maintaining an Article Database;
receiving an Article Database inquiry;
determining if the inquiry relates to a database modification or a database retrieval;
permitting new data storage into the Article Database if valid authorization information is received in response to a database modification inquiry; and
permitting retrieval of Article Database information if valid authorization information is received in response to a database retrieval inquiry;
wherein the Article Database contains a plurality of article identification numbers, each of which is uniquely assigned to and associated with a different article having a label that is permanently affixed thereto, and also contains a plurality of data records, each of which is linked to one of the article identification numbers, each data record containing initial article information that relates to the sales article and is associated with customer identification for a customer who purchases the sales article, and wherein the database computer is connected to a computer network and the data records are supplemented with added information that relates to the sales article, such that the information in the Article Database can be accessed from a data access computer of the computer network by an authorized customer to retrieve the initial article information, customer identification, and added article information for the identified sales article.

55. A method as defined in claim 54, wherein maintaining the Article Database comprises:
assigning a unique identification number to the sales article;
storing initial article information into the Article Database in accordance with the article identification number; and
associating an article customer identification with the article information in the database for a customer who purchases the sales article.

56. A method as defined in claim 55, wherein assigning the article identification number occurs at approximately the time of sales article manufacture.

57. A method as defined in claim 55, wherein assigning the article identification number occurs at approximately the time the customer purchases the sales article.

58. A method as defined in claim 55, wherein assigning the article identification number comprises recording the identification number onto a label that is permanently affixed to the sales article.

59. A method as defined in claim 55, wherein storing initial article information comprises storing information other than article related inherent characteristics.

60. A method as defined in claim 55, wherein storing initial article information comprises storing customer information, including customer name and date of purchase.

61. A method as defined in claim 55, wherein permitting new data storage into the Article Database comprises storing customer information, including customer name and date of purchase, into the Article Database.

62. A method as defined in claim 55, wherein permitting new data storage into the Article Database comprises storing information comprising date of adding information and location from which the information was added.

63. A method as defined in claim 55, wherein storing initial article information comprises storing the information into a computer network database.

64. A method as defined in claim 55, wherein permitting retrieval of Article Database information comprises accessing a computer network database in which the article information is stored.

65. A method as defined in claim 55, wherein the Article Database is stored on a computer network, and permitting new data storage into the Article Database comprises:
providing a network authorization code to gain access to the computer network;
providing a database authorization code to gain access to the Article Database; and
storing added information into the Article Database.

66. A method as defined in claim 55, wherein the Article Database is stored on a computer network, and permitting retrieval of Article Database information comprises:
providing a network authorization code to gain access to the computer network;
providing a database authorization code to gain access to the Article Database; and
retrieving information stored in the Article Database.

67. A method as defined in claim 55, wherein the sales article comprises a garment worn by an individual.

68. A method as defined in claim 55, wherein the sales article comprises a furnishing product.
